(19) United States
(12) Patent Application Publication
(10) Pub. No.: US 2023/0127707 A1
(43) Pub. Date: Apr. 27, 2023

(54) MOVING BODY, SMALL AIRCRAFT AND METHOD FOR DELIVERING GOODS USING DRONE

(71) Applicant: PATENT INVESTMENT Co., Ltd., Tokyo (JP)

(72) Inventor: Daigo Kusano, Tokyo (JP)

(73) Assignee: PATENT INVESTMENT Co., Ltd., Tokyo (JP)

(21) Appl. No.: 18/048,156

(22) Filed: Oct. 20, 2022

(30) Foreign Application Priority Data
Oct. 21, 2021 (JP) 2021-172751

(51) Int. Cl. G06Q 10/0832; G08G 5/00; B64C 39/02; B64U 80/80; B64U 10/80; G05D 1/00; G06Q 50/26

(52) U.S. Cl. CPC G06Q 10/0832; G08G 5/0004; B64C 39/024; B64U 80/80; B64U 10/80; G05D 1/0094; G05D 1/0011; G06Q 50/265; B64U 2101/20

(57) ABSTRACT

The moving body of the present invention is a moving body that has a weight of 300 kg or less and is activated by a user to move, the moving body comprising: a movement mechanism for moving; a communication unit for performing communication; a control unit that controls the moving mechanism so that the moving body moves when communication between the communication unit and an external communication device is not possible; and an attachment for fixing, wherein the control unit controls the moving mechanism so that the moving body moves when fixation by the attachment is released, and wherein the communication unit transmits user-related information, which is information related to the user, to the external communication device when the communication between the communication unit and the external communication device is possible.

### CROSS-REFERENCES TO RELATED APPLICATIONS

This application claims priority to Japanese Patent Application No. 2021-172751 filed on Oct. 21, 2021, which is hereby incorporated herein by reference in its entirety.

### TECHNICAL FIELD

The present invention relates to a moving body, a small aircraft and a method for delivering goods using a drone.

### BACKGROUND ART

### Citations List

### Patent Literature

Patent document 1: JP 2015-85755A
Patent document 2: JP 2009-199542A

### SUMMARY OF INVENTION

### Technical Problems

An object of the present invention is to provide a moving body that moves when communication with an external communication device is not possible and transmits information related to a user to the external communication device when the communication is possible, and a management system, a moving body system, a program and a computer-readable storage medium related to the moving body.

### BRIEF DESCRIPTION OF DRAWINGS

FIG. 1 is a schematic diagram showing an example of usage patterns of a moving body according to an embodiment of the present invention.

FIG. 2 is a block diagram showing a configuration of the moving body and a management system.

FIG. 3 is a block diagram showing a configuration of a computer of the moving body.

FIG. 4 is a block diagram showing a configuration of a computer of the management system.

FIG. 5 is a flowchart for explaining operation of the moving body in normal mode.

FIG. 6 is a flowchart for explaining operation of the moving body in test mode.

FIG. 7 is a flowchart for explaining processing flow in the management system.

FIG. 8 is a block diagram showing a configuration of a moving body system of the present invention.

FIG. 9 is a block diagram following FIG. 8 showing the configuration of the moving body system of the present invention.

FIG. 10 is a block diagram showing a configuration of a computer of the moving body system.

FIG. 11 is another block diagram showing the configuration of the moving body system.

FIG. 12 is a diagram showing the configuration of the moving body according to another embodiment of the present invention.

FIG. 13 is a diagram showing the configuration of the moving body according to still another embodiment of the present invention.

FIG. 14 is a diagram showing the configuration of the moving body according to still another embodiment of the present invention.

FIG. 15 is a diagram showing a relationship between a transmission interval of user-related information of the moving body of the present invention and a communication success rate.

FIG. 16 is a diagram showing a relationship between a volume of the moving body of the present invention and a ratio of a space that can be stored.

FIG. 17 is a diagram showing a relationship between a maximum flying time of the moving body of the present invention and the communication success rate.

FIG. 18 is a diagram showing a flow of a method for delivering according to another embodiment of the present invention.

FIG. 19 illustrates an operation device capable of operating a drone according to another embodiment of the present invention.

FIG. 20 is a diagram showing a usage example of the moving body according to still another embodiment of the present invention.

FIG. 21 is a diagram showing a relationship between a weight of the moving body of the present invention and a horizontal shift when the moving body climbs to an altitude of 30 m at a wind speed of 20 m/s and then lands.

FIG. 22 is a diagram showing a relationship between the altitude and a communication distance of the moving body according to the present invention.

FIG. 23 is a diagram showing a relationship between the altitude of the moving body of the present invention and a possibility of crash.

FIG. 24 is a diagram showing a usage example of the moving body according to still another embodiment of the present invention.

### DESCRIPTION OF EMBODIMENTS

First, an outline of the present embodiment will be described, and then specific contents of the present embodiment will be described with reference to the drawings. In the following description, a term moving body user U refers to a user U who uses a moving body 10 such as, for example, a person who can be a search target (climber or hiker) who uses the moving body 10 to request rescue from a searcher in an event of an accident or distress during mountain climbing or hiking and a person who can be a search target who uses the moving body 10 to request rescue from a searcher in an event of a disaster such as an earthquake or a landslide. It should be noted that the person who receives a rescue request from moving body user U using moving body 10 may request another person to search. In addition, the moving body user U may include a person other than the person who can be the search target for whom the rescue request is made such as, for example, a person who requests home delivery, work, business trip service, transportation, etc., and uses the moving body 10 simply to place a predetermined order.

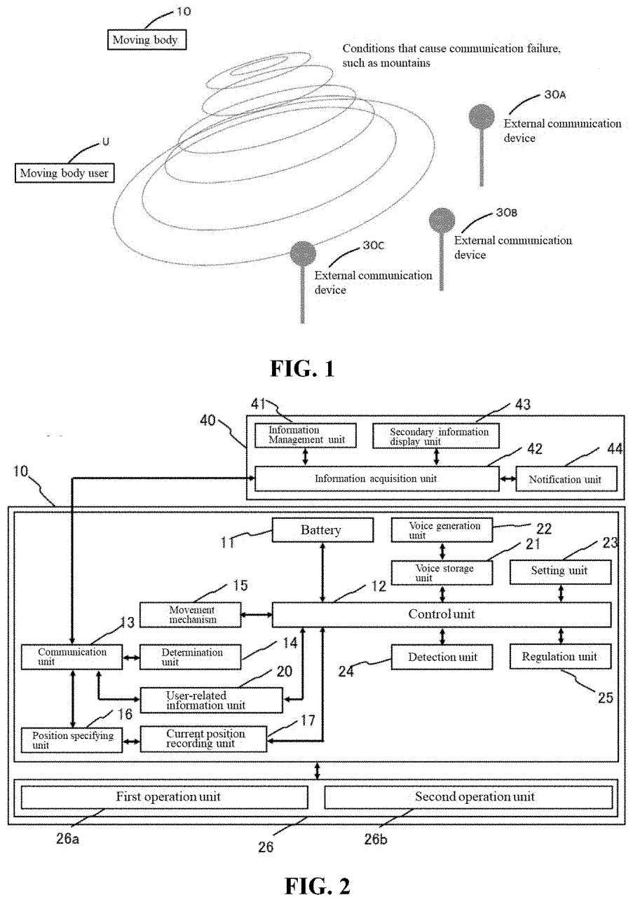

An outline of an example of the present embodiment will be described with reference to FIG. 1. In this embodiment, the moving body user U activates the moving body 10. As a preferred embodiment, the moving body 10 is configured to be portable and mountable on a means of transportation by the moving body user U.

Here, being portable by the moving body user U means, for example, a configuration that the moving body user U can hold and carry by hand, can be held and carried by the moving body user U, or can be carried in a rucksack or the like by the moving body user U, and it is preferable to have a portable configuration. The portable configuration can include a collapsible configuration, a disassemblable configuration, or an assemblable configuration.

Further, being mountable on the means of transportation by the moving body user U means that the moving body user U can load or place the moving body 10 on the means of transportation such as a car, ship, or airplane, and a large moving body 10 is meant to be excluded.

That is, the moving body 10 is configured to be able to move in the sky, land, sea (sea, undersea, seabed), etc. and as the configuration that is portable and mountable on the means of transportation by the moving body user U, it is preferable to use an aircraft that moves by flying, such as a radio-controlled helicopter or a drone (unmanned aerial vehicle). Radio-controlled helicopters and drones can be equipped with, for example, propellers, flight controllers, substrates, communication modules, antennas, atmospheric pressure sensors, gyro sensors, acceleration sensors, ultrasonic sensors, GPS, cameras, and the like. The moving body 10 preferably moves automatically.

A weight of the moving body 10 is preferably 300 kg or less. It is preferable that the moving body 10 excludes a large moving body 10 (helicopters, airships, ships, cars, robots, etc.) weighing more than 300 kg. In addition, even if the moving body 10 is configured to be portable and mountable on the means of transportation by the moving body user U, the moving body 10 may be placed or installed in a house, office, or the like, and the moving body 10 may be used in the event of the disaster or the like.

External communication devices 30A to 30C are devices for communication provided apart from the moving body 10 and correspond to examples of sites. The external communication devices 30A to 30C are, for example, base stations, terminals, artificial satellites, and the like. In this regard, the site is a characteristic object (e.g., building, machine, etc.) that occupies a position and whose position can be identified, and if the position can be specified, the position may or may not change with time.

[Configuration]

A configuration example of the moving body 10 and a management system 40 according to the present embodiment will be described with reference to FIG. 2.

<Configuration of Moving Body 10>

In this embodiment, the moving body 10 includes a battery 11, a control unit 12, a communication unit 13, a determination unit 14, a moving mechanism 15, a position specifying unit 16, a current position recording unit 17, a user-related information unit 20, a voice storage unit 21, a voice generation unit 22, a setting unit 23, a detection unit 24, a regulation unit 25 and an operation unit 26. The moving body 10 also includes a power switch (not shown) for starting power supply to each part of the moving body 10.

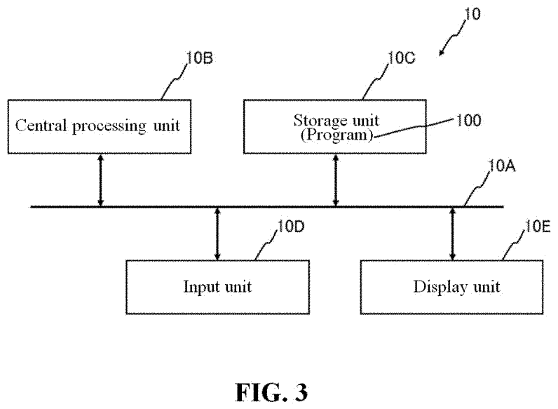

The moving body 10 has a general configuration as a computer. As shown in FIG. 3, the moving body 10 includes a central processing unit (CPU, GPU, DSP) 10B, a storage unit (ROM, RAM, hard disk, cache memory) 10C, an input unit (touch panel, buttons) 10D, a display unit (liquid crystal display) 10E and the like, which are interconnected via a bus 10A. The storage unit 10C functions as a computer-readable storage medium. A program 100 is stored in the storage unit 10C. By executing the program 100, each unit 11 to 17 and 20 to 26 of the moving body 10 can be made to function.

(Battery 11)

When the power switch is turned on, the battery 11 supplies power to the control unit 12, the communication unit 13, the determination unit 14, the moving mechanism 15, the position specifying unit 16, the current position recording unit 17, the user-related information unit 20, the voice storage unit 21, the voice generation unit 22, the setting unit 23, the detection unit 24, the regulation unit 25 and the operation unit 26.

The battery 11 is widely used, for example, in miniaturized radio-controlled helicopters, drones, etc., and may be provided with a single cell or a plurality of cells of a lithium ion battery, a lithium polymer battery, a fuel cell, etc., which are compact, lightweight and rechargeable.

(Control Unit 12)

The control unit 12 controls the battery 11, the communication unit 13, the determination unit 14, the moving mechanism 15, the position specifying unit 16, the current position recording unit 17, the user-related information unit 20, the voice storage unit 21, the voice generation unit 22, the setting unit 23, the detection unit 25 and the regulation unit 26. For example, the control unit 12 controls the moving mechanism 15 when communication between the communication unit 13 and the external communication devices 30A to 30C cannot be established.

The control performed by the control unit 12 may be automatically performed by the program 100 described above. Alternatively, the moving body user U may transmit a control signal to the moving body 10 via a controller, and the communication unit 13 may receive the control signal.

(Communication Unit 13)

The communication unit 13 has a transmission/reception antenna and receives control from the control unit 12 to transmit and receive signals. The communication unit 13 transmits predetermined transmission signals to the external communication devices 30A to 30C and receives signals from the external communication devices 30A to 30C. When the communication unit 13 receives the signals from the external communication devices 30A to 30C, the communication unit 13 transmits the received signals to the determination unit 14. Further, the communication unit 13 does not transmit a signal to the determination unit 14 when no signal is received from the external communication devices 30A to 30C.

For the communication between the communication unit 13 and the external communication devices 30A to 30C, for example, the communication unit 13 may send information (user-related information, etc.) to the external communication devices 30A to 30C at predetermined intervals (for example, once every 10 seconds).

Further, a frequency band in which transmission/reception of the transmission/reception antenna provided in the communication unit 13 is possible can be made variable. The receiving antenna may be omnidirectionally arranged so that the signals from the external communication devices 30A to 30C and user terminals (for example, the controller, the mobile terminal, etc.; not shown) can be received from all directions. The transmission antenna is preferably arranged omnidirectionally so that the transmission signals can be transmitted in all directions.

The communication unit 13 can transmit the user-related information stored or acquired by the user-related information unit 20 to the external communication devices 30A to 30C.

(Determination Unit 14)

The determination unit 14 receives the received signal from the communication unit 13.

When the received signal is received from the communication unit 13, communication between the communication unit 13 and the external communication devices 30A to 30C is possible, and the determination unit 14 determines that the communication between the communication unit 13 and the external communication devices 30A to 30C has been established. The determination unit 14 transmits a communication establishment signal to the control unit 12.

When the received signal is not received from the communication unit 13 within a predetermined time, the communication between the communication unit 13 and the external communication devices 30A to 30C is not possible, and the determination unit 14 determines that the communication between the communication unit 13 and the external communication devices 30A to 30C has not been established. The determination unit 14 transmits a communication non-establishment signal (a signal notifying that communication has not been established (communication is not possible)) to the control unit 12.

The movement mechanism 15 may be any mechanism that moves the moving body 10 in a controllable manner, for example, by using a motor (not shown) driven by power supply from the battery 11 as a power source and using a rotation of a motor shaft to obtain buoyancy, thrust, etc. through members such as propellers. Alternatively, other moving mechanisms may be employed.

Here, before the moving body 10 moves from its current position, more specifically, before the moving body 10 moves from its current position after being activated by the moving body user U and before it starts to move and when the communication unit 13 can communicate with the external communication devices 30A to 30C, the moving mechanism 15 can be controlled by the control unit 12 so as not to move the moving body 10.

Namely, before the moving body 10 moves from its current position, more specifically, before the moving body 10 moves from its current position after being activated by the moving body user U and before it starts to move and when the communication unit 13 can communicate with the external communication devices 30A to 30C, the communication unit 13 can transmit the user-related information to the external communication devices 30A to 30C without moving the moving body 10.

Further, as an operation of the moving mechanism 15, for example, when the communication unit 13 succeeds in transmitting the user-related information to the external communication devices 30A to 30C, the control unit 12 can control the moving mechanism 15 to change the moving direction of the moving body 10. For example, when the communication unit 13 successfully transmits to the external communication devices 30A to 30C, the control unit 12 can control the movement mechanism 15 so as to change the direction in which the moving body 10 moves from upward to downward and from left to right. Thereby, the moving body 10 can be returned to the moving body user U.

Note that the time when the communication unit 13 has successfully transmitted the user-related information to the external communication devices 30A to 30C can be the time when the communication unit 13 receives the signal from the external communication devices 30A to 30C, or the time when the determination unit 14 receives the received signal from the communication unit 13.

(Position Specifying Unit 16)

The position specifying unit 16 includes an input unit (not shown) and receives a physical signal (“physical input”) regarding the current position of the moving body 10 (the position where the moving body 10 exists) via the input unit. The physical input includes, for example, temperature/pressure signals, GPS (Global Positioning System), navigation signals from a global positioning satellite system and the like.

The position specifying unit 16 analyzes the physical input and specifies the current position.

The position specifying unit 16 specifies the current position of the moving body 10 if the power switch provided to the moving body 10 is turned on.

The position specifying unit 16 records the specified current position in the current position recording unit 17.

The position specifying unit 16 may specify the current position of the moving body 10 at predetermined time intervals. Further, the position specifying unit 16 may record the current position specified at predetermined time intervals in the current position recording unit 17 at the predetermined time intervals. Note that the current position may be recorded together with the time when the current position was recorded. In addition, the position specifying unit 16 may be set in advance so that under the control of the control unit 12, the current position of the moving body 10 before it starts moving after being activated by the moving body user U is recorded in the current position recording unit 17. By configuring the position specifying unit 16 in this way, the current position specified by the position specifying unit 16 is considered to be the same as (or near) the position where the moving body 10 or the moving body user U exists and the information on the location where the moving body 10 or moving body user U was present can be transmitted to the external communication devices 30A-30C. Therefore, when a third party obtains the information on the location where the moving body 10 or the moving body user U was present through the external communication devices 30A to 30C, the position where the moving body 10 or the moving body user U was present can be grasped.

The current position specified by the position specifying unit 16 may be at least one of latitude, longitude, depth, and altitude.

Further, for example, a three-axis acceleration sensor is installed as the input unit, and the position specifying unit 16 obtains a movement trajectory from a movement start point by analysis by inertial navigation, and a current three-dimensional position relative to the movement start point may be identified.

(Current Position Recording Unit 17)

The current position recording unit 17 records the current position specified by the position specifying unit 16.

(User-Related Information Unit 20)

The user-related information unit 20 stores the information related to the moving body user U (hereinafter referred to as “user-related information”). The user-related information stored in the user-related information unit 20 can include, for example, personal information such as the moving body user U and contact information (name, address, email address) of a person related to the moving body user U, and various types of information about the moving body 10.

That is, the user-related information can include not only direct information of the moving body user U but also information such as identification information of the moving body 10 operated by the moving body user U, position information of the current position of the moving body 10 and images of the moving body user U and surroundings. The identification information of the moving body 10 can include a product number (ID number) of the moving body 10, a product number (ID number) of a communication module and the like. The communication unit 13 can transmit the identification information of the moving body 10 to the external communication device 30 when communication with the external communication devices 30A to 30C is possible.

Alternatively, the user-related information unit 20 may be configured to include a simple input device (for example, a simple keyboard, a recording microphone, a digital camera, a simple medical device, etc.) so that the user-related information is additionally input and acquired at any time via the simple input device. A storage format of the user-related information may be, for example, a character string, voice, image or the like. Further, acquisition of the user-related information may be based on input from an external device other than the moving body 10.

Additionally, the user-related information may include information indicating that the moving body user U is in an emergency. The information indicating the emergency situation preferably includes information indicating distress or damage, information indicating a request for help and the like. Further, the user-related information may include, for example, information (personal information such as name and address) with which the moving body user U can be recognized, medical information (body temperature, blood pressure, etc.) accumulated on the spot, state of the moving body user U, messages from the moving body user U (moving route so far, future action plan, etc.) and environmental information around moving body user U (temperature, humidity, etc.).

(Voice Information Storage Unit 21)

The voice information storage unit 21 can store voice information. The voice can be a voice for explaining the operation and function of the moving body 10. Further, the voice can be a voice for notifying the moving body user U that the communication unit 13 has successfully transmitted the user-related information to the external communication devices 30A to 30C.

(Voice Generation Unit 22)

The voice generation unit 22 can call out voice information from the voice information storage unit 21 and generate voice. The voice generation unit 22 can generate a voice before the moving body 10 starts moving. By turning on the power switch of the moving body 10 and operating the operation unit 26, a predetermined signal may be output to call out voice information from the voice storage unit 21, and the voice generation unit 22 may be configured to play voice guidance.

(Setting Unit 23)

The setting unit 23 can set the time for the moving body 10 to move. Further, the setting unit 23 can set a distance that the moving body 10 moves. The moving distance of the moving body 10 can be a distance in the horizontal direction and the vertical direction. Further, the moving distance of the moving body 10 can be calculated by calculating a distance actually moved by “moving speed of the moving body 10×moving time of the moving body 10”. Alternatively, a straight-line distance from the position before the moving body 10 starts moving to the position reached by the moving body 10 may be used as the moving distance of the moving body 10. For example, if the moving body 10 is an aircraft, the altitude reached by the moving body 10 (the altitude from the position where the moving body 10 started to rise) may be set, and the moving distance of the moving body 10 may be twice a numerical value of the altitude (in this case, the moving body 10 will land after moving to that altitude). Furthermore, the setting unit 23 can set the direction in which the moving body 10 moves. The moving direction of the moving body 10 set by the setting unit 23 includes the vertical direction and the horizontal direction, and the control unit 12 can control the moving mechanism 15 so as to reciprocate in the vertical direction and the horizontal direction.

Furthermore, when the moving body 10 is the aircraft, the setting unit 23 can set the altitude at which the aircraft ascends. The position where the moving body 10 started to rise can be the ground, for example.

Examples of communication methods of the communication unit 13 include LPWA (Sigfox, LoRa, etc.), 4G, 5G, Wi-Fi, etc., and the moving body 10 can be equipped with a communication module compatible with these communication methods. LPWA is preferable from the viewpoint of communication distance. The frequency band of radio waves used for communication by the communication unit 13 preferably has a long wavelength of 900 to 1000 MHz.

(Operation Unit 26)

The operation unit 26 is for operating the moving body 10.

<Configuration of Management System 40>

The management system 40 includes an information management unit 41, an information acquisition unit 42, a secondary information display unit 43, and a notification unit 44.

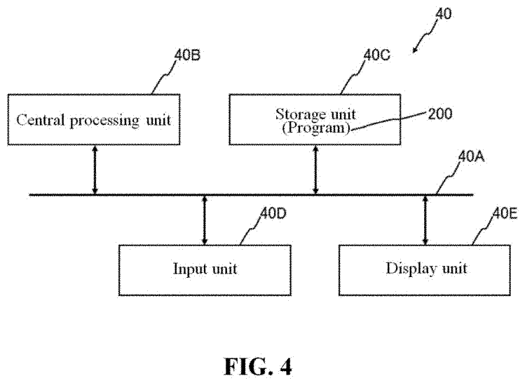

The management system 40 has a general configuration as a computer. As shown in FIG. 4, the management system 40 includes a central processing unit (CPU, GPU, DSP) 40B, a storage unit (ROM, RAM, hard disk, cache memory) 40C, an input unit (keyboard, touch panel, mouse) 40D, a display unit (liquid crystal display) 40E and the like, which are interconnected via a bus 40A. In addition, the management system 40 can communicate with the external communication devices 30A to 30C via a network such as the Internet, etc., and can acquire the user-related information and the like transmitted from the moving body 10 through the external communication devices 30A to 30C. The storage unit 40C functions as a computer-readable storage medium. A program 200 is stored in the storage unit 40C. By executing the program 200, each part 41 to 44 of the management system 40 can be made to function.

(Information Management Unit 41)

The information management unit 41 can previously store and manage the user-related information including identification information of the moving body 10 and personal information of the moving body user U (name, address, email address, etc.). The information management unit 41 can store and manage the identification information of the moving body 10 and the personal information of the moving body user U in association with each other. The user-related information is not limited to information of one person and may be information of multiple persons.

The information acquisition unit 42 can input and acquire the user-related information transmitted from the communication unit 13 to the external communication devices 30A to 30C as predetermined signal information. The information management unit 41 can superimpose and store and manage the user-related information acquired by the information acquisition unit 42 (for example, position information of the current position of the moving body 10, information such as images of the moving body user U and surroundings). Thereby, the information sent from the moving body 10 can be additionally managed.

When the information acquisition unit 42 acquires the user-related information, the notification unit 44 can notify a predetermined contact (family of the moving body user U, rescue company, security company, etc.) of the content including that the information acquisition unit 42 has acquired the user-related information, for example, by e-mail. The notification may include a notification regarding a rescue request for rescue of the moving body user U or a person related to the moving body user U. Note that the person related to the moving body user U can include a person near the moving body user U who is injured or seriously injured (a person for whom the moving body user U has received a rescue request).

[Operation of Moving Body 10]

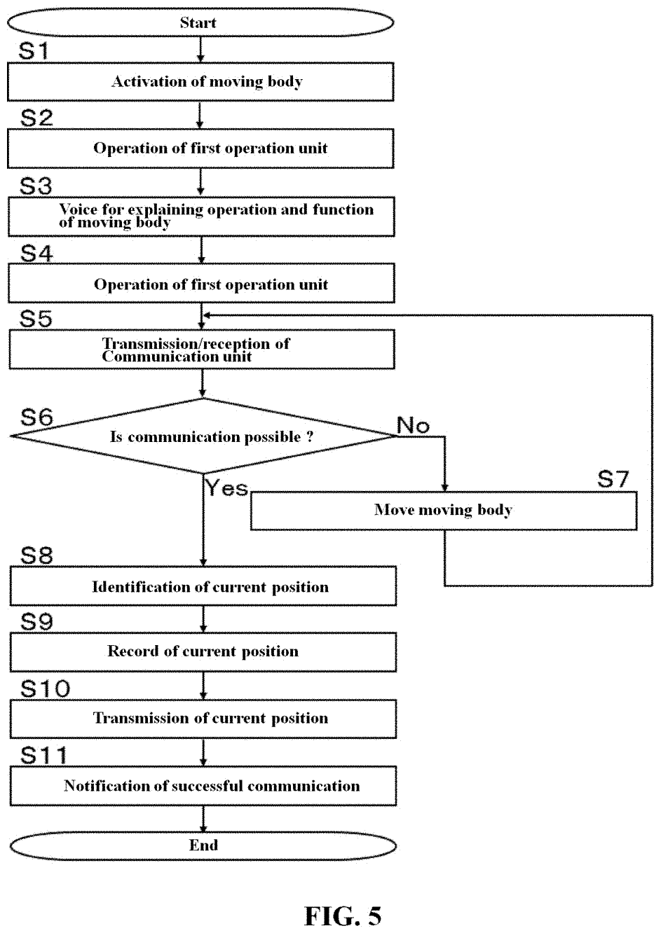

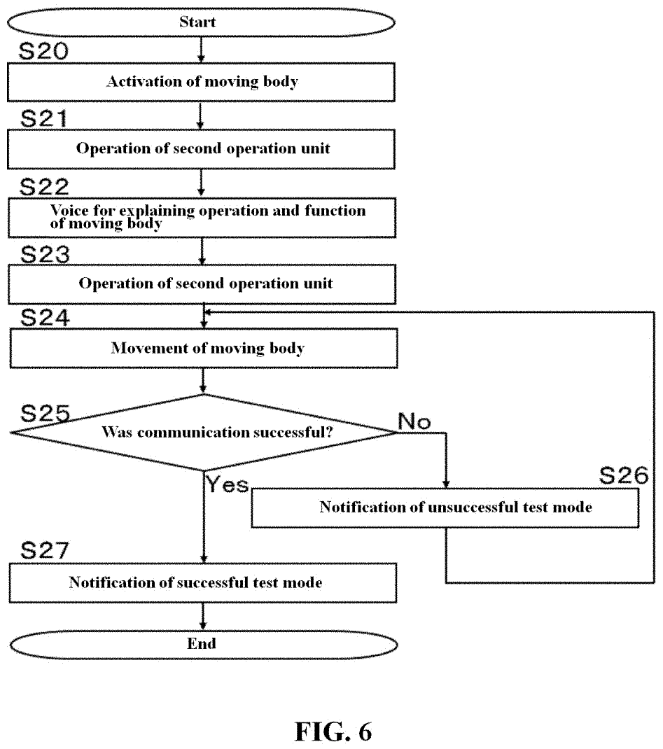

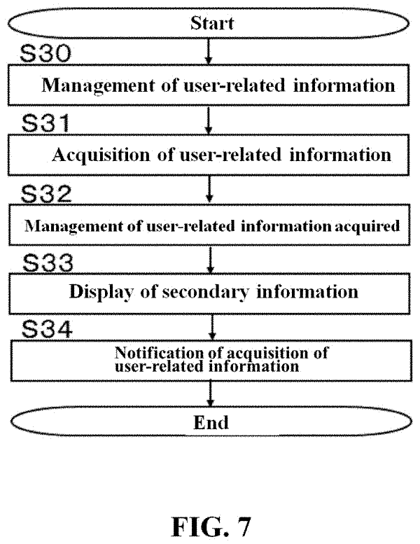

FIG. 5 is a diagram showing a flow of processing in the moving body 10 of this embodiment. Below, referring to FIG. 5, the operation of the moving body 10 will be described according to step numbers (S1 to S11).

(S1)

When the moving body user U is in distress, the power switch of the moving body 10 is turned on to activate the moving body 10.

(S2)

The moving body user U operates a first operation unit 26a to request help.

(S3)

The voice generation unit 22 calls up the voice information from the voice storage unit 21 and emits the voice. This voice can be the voice for explaining the operation and function of the moving body 10.

(S4)

The moving body user U operates the first operation unit 26a again according to the voice according to S3. By this operation, setting of time, distance, altitude and direction by the setting unit 23 is started.

(S5)

According to the control from the control unit 12, the communication unit 13 performs transmission/reception with the external communication devices 30A to 30C. The communication unit 13 transmits the received signal to the determination unit 14.

(S6)

When the determination unit 14 does not receive the received signal within a predetermined time, the communication between the communication unit 13 and the external communication devices 30A to 30C is not possible, and the determination unit 14 determines that the communication between the communication unit 13 and the external communication devices 30A to 30C has not been established (S6; No). Further, the determination unit 14 transmits the communication non-establishment signal to the control unit 12 and advances the process to the next step (S7: move the moving body 10).

When the determination unit 14 receives the received signal within a predetermined time, the communication between the communication unit 13 and the external communication devices 30A to 30C is possible, and the determination unit 14 determines that the communication between the communication unit 13 and the external communication devices 30A to 30C has been established (S6; Yes). Further, the determination unit 14 transmits the communication establishment signal to the control unit 12 and advances the process to the next step (S8: identify the current position of the moving body 10).

When the received signal is received, the communication between the communication unit 13 and the external communication devices 30A to 30C is possible, and the determination unit 14 determines that the communication between the communication unit 13 and the external communication devices 30A to 30C has been established (S6; Yes). Further, the determination unit 14 transmits the communication establishment signal to the control unit 12 and advances the process to the next step (S8: identify the current position of the moving body 10).

(S7)

Upon receiving the communication non-establishment signal transmitted from the determination unit 14, the control unit 12 determines that the communication between the communication unit 13 and the external communication devices 30A to 30C is not possible and controls the position specifying unit 16 to move the moving body 10. The process is returned to step (S5).

(S8)

Upon receiving the communication establishment signal transmitted from the determination unit 14, the control unit 12 determines that the communication between the communication unit 13 and the external communication devices 30A to 30C is possible and controls the position specifying unit 16 to specify the current position of the moving body 10.

(S9)

The control unit 12 controls the position specifying unit 16 to record the current position of the moving body 10 specified by the position specifying unit 16 in the current position recording unit 17.

(S10)

The control unit 12 controls the communication unit 13 and transmits the specified current position from the communication unit 13 to the external communication devices 30A to 30C.

(S11)

The voice generation unit 22 calls up the voice information from the voice storage unit 21 and emits voice.

[Moving Body System]

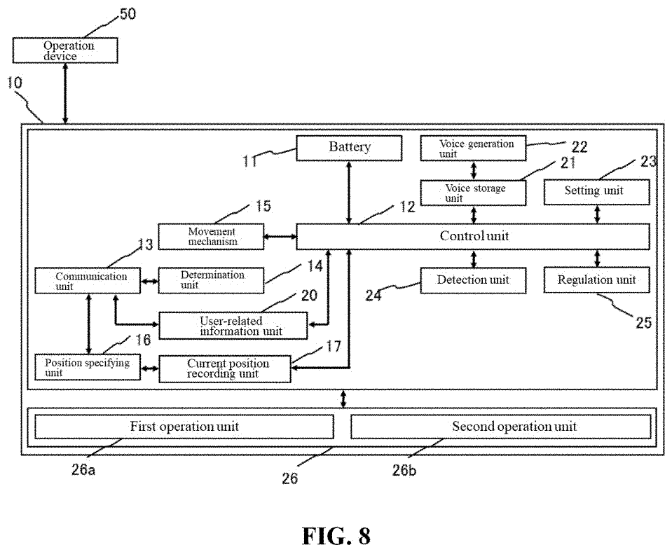

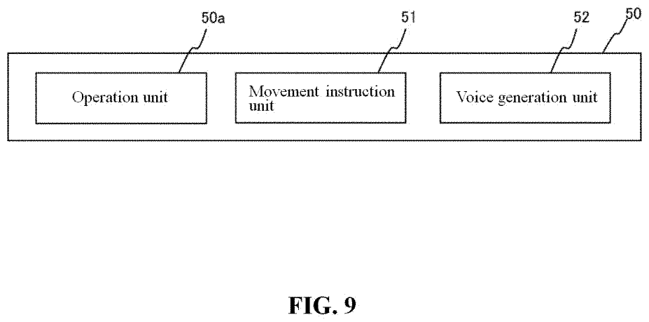

Next, the moving body system 1 of the present invention will be explained. The moving body system 1 has the above-described moving body 10 and an operation device 50 for operating the moving body 10 as shown in FIGS. 8 and 9.

The operation device 50 is separate from the moving body 10. The operation device 50 has a movement instruction unit 51 and a voice generation unit 52, the movement instruction unit 51 is a functional unit that issues an instruction (movement instruction) for the moving body 10 to move, and the voice generation unit 52 is a functional unit that emits voice.

The operation device 50 can be, for example, a portable device (a terminal device such as a controller that can serve as an interface for the user U to perform a predetermined operation) or a device mounted on a vehicle, ship or the like (a terminal device such as a controller that can serve as an interface for the user U to perform a predetermined operation). The operation device 50 has an operation unit 50a including push buttons, images of push buttons provided on a touch panel, levers and the like and the operation unit 50a is interlocked with the moving body 10. By operating (pressing) the operation unit 50a, the movement instruction unit 51 outputs a predetermined control signal, and the moving body 10 can be moved.

The instruction to move the moving body 10 by the operation device 50 can be performed by, for example, either wireless communication or wired communication via the communication unit 13, but it is more preferable that the communication between the operation device 50 and the moving body 10 is performed wirelessly. Wireless communication or wired communication between the operation device 50 and the moving body 10 may be performed all the time.

Further, the movement instruction may be given by a method other than communication, such as by simply operating a button, lever or the like on the operation device 50 interlocked with the moving body 10.

The movement instruction by the movement instruction unit 51 may be an instruction for the moving body 10 to start moving, or may be an instruction for moving left, right, up and down, moving for landing and the like. As for the movement instruction, only the movement start instruction may be given by the moving body 10 (movement instruction unit 51), and after the movement is started, the moving body 10 may move autonomously.

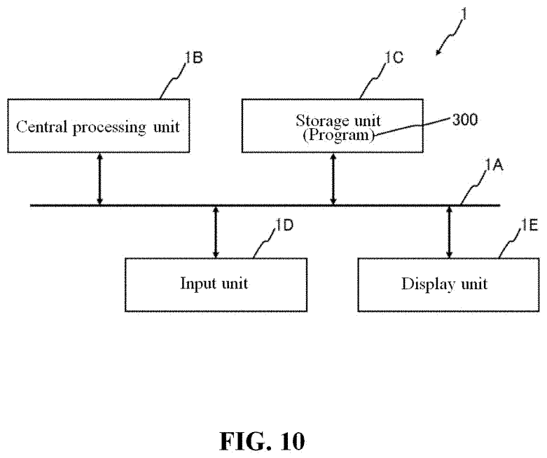

The moving body system 1 has a general configuration as a computer as shown in FIG. 10.

Note that the moving body system 1 may further include the management system 40 described above as shown in FIG. 11.

### Another Embodiment of Moving Body

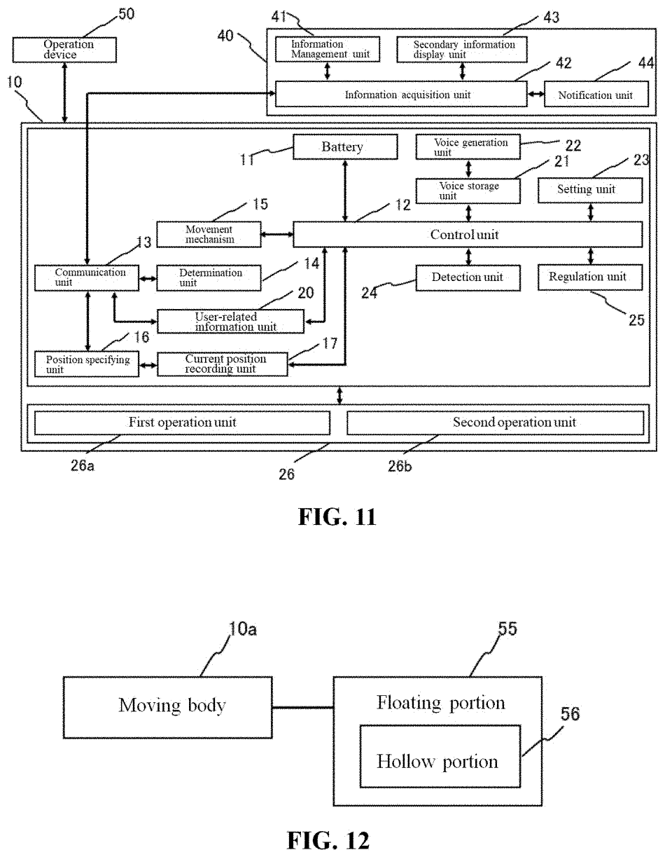

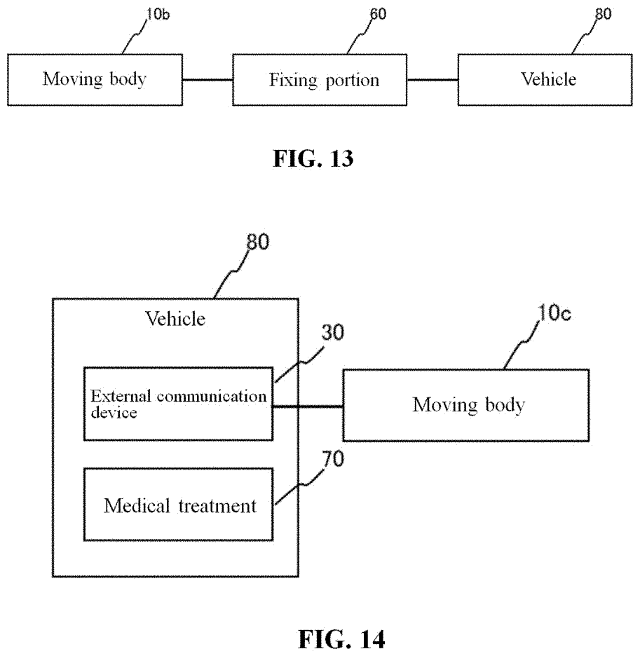

Another embodiment of the moving body of the present invention will be described with reference to FIG. 12. In the following description and FIG. 12, configurations denoted by the same reference numerals as in the above-described embodiment and configurations without description are assumed to be the same as in the above-described embodiment, and description thereof may be omitted (the same applies to FIG. 13 and subsequent figures).

A moving body 10a according to another embodiment of the present invention is configured to further include a floating portion 55 for floating on water. The moving body 10a further includes the floating portion 55, thereby preventing the moving body 10a from sinking in water.

That is, the floating portion 55 may be configured, for example, by using a light member (a member with low density) or by a hollow structure. By providing the floating portion 55 so as to float on water, the moving body 10a may be able to move on a surface of the water (above the water) or take off from the surface of the water.

Further, the floating portion 55 may be configured by a specific (partial) portion of the moving body 10a. Further, the floating portion 55 may be attached to the moving body 10a as a separate body. Furthermore, the floating portion 55 may be composed of all parts of the moving body 10a (the entire moving body 10a).

For example, the floating portion 55 may be the moving body 10a itself configured to have a density lower than that of water. A member (material) forming the floating portion 55 may be, for example, a rubber material or a plastic material.

Further, the floating portion 55 may have a hollow portion 56 capable of sealing air. By sealing the air in the hollow portion 56, the movable body 10a can be easily floated on water. The air in the hollow portion 56 may be always filled or may be filled when the moving body 10a is in use. The floating portion 55 may have a fixed shape or may have a non-fixed shape such that it deflates or swells as air is drawn in and out. The term “capable of sealing air” does not necessarily mean that the air can be completely prevented from flowing out of the hollow portion 56, and for example, a state in which part of the air flows out of the hollow portion 56 over time. In other words, it is sufficient that a predetermined amount of the air can be retained inside the hollow portion 56 after a predetermined period of time has elapsed.

Further, the floating portion 55 may be detachable (attachable and detachable). By making it detachable, the floating part 55 can be attached and detached depending on the situation of use. For example, it is assumed that when using the moving body 10a on water (sea, lake, etc.), the floating part 55 is attached, and when using the moving body 10a on land, the floating part 55 is detached and not attached. The attachment and detachment of the floating portion 55 may be performed using members such as magnets and screws.

Alternatively, the floating portion 55 may use a mechanical propulsive force such as a screw or a thruster to float the moving body 10a on the water.

Here, the moving body 10a according to another embodiment of the present invention may be an aircraft that moves by flying. By having the floating portion 55, submersion in water during or after flight can be suppressed.

The moving body 10a may be used underwater or on water and the communication unit 13 may communicate with the external communication device 30 on the ground. Even when the moving body user U is underwater or on the water, it is possible to facilitate communication with the external communication device 30 on the ground by flying. In addition, when the moving body 10a is used in water, it is preferable that the moving body 10a has water resistance and can move in the water and in the air. For example, the moving body 10a may be a so-called aquatic drone. It should be noted that after the moving body 10a floats up to the surface of the water due to buoyancy, the moving body 10a may take off from the surface of the water and move in the air. “On water” means a position near the surface of the water. That is, it may be at a height equivalent to the water surface, a position above the water surface, or a position above a ship or boat floating on water. For example, the moving body 10a can be used by the moving body user U when he/she is stuck on the seabed, drowns in the sea, or when the ship on board is in distress.

Still another embodiment of the moving body of the present invention will be described with reference to FIG. 13.

A moving body 10b according to another embodiment of the present invention further has a fixing portion 60 for fixing the moving body 10b to a predetermined vehicle 80, and the control unit 12 can control the moving mechanism 15 so that the moving body 10b moves when the fixing by the fixing unit 60 is released. The fixing portion 60 allows the vehicle 10b to be mounted in a fixed position on the vehicle 80. The fixing of the moving body 10b to the vehicle 80 (the state in which the moving body 10b is fixed to the vehicle 80) may be automatically released by the moving body 10b or the vehicle 80, or may be manually released by the moving body user U. After the moving body 10b is released from the vehicle 80, the moving body 10b may start to move by the operation of the moving body user U or may start to move automatically. Fixing the moving body 10b to the vehicle 80 may be performed by, for example, magnets, electromagnets, screws, adhesives or the like. The moving body 10b may have a detector for detecting release of fixation by the fixing portion 60, and the control unit 12 may control the moving mechanism 15 so that the moving body 10b moves based on a detection signal of the detector. Alternatively, the control unit 12 may perform predetermined control by operating a button or the like provided on the vehicle 80 to release the fixation. The vehicle 80 is a vehicle such as a helicopter, an ambulance, a taxi, etc. in which people can board.

Still another embodiment of the moving body of the present invention will be described with reference to FIG. 14.

In another embodiment of the present invention, the external communication device 30 is installed in the boardable vehicle 80 so that the external communication device 30 can move simultaneously with the vehicle 80. In addition, a person (for example, a rescuer) can operate the vehicle 80 in response to communication from the moving body 10c, for example, to go to a place where the moving body user U is present. The boardable vehicle 80 is a vehicle such as a helicopter, an ambulance, a taxi or the like, in which a person can board. In addition, the external communication device 30 may transmit predetermined information to the moving body 10c (for example, information related to the fact that the boardable vehicle 80 is heading for the rescue of the moving body user U, positional information of the boardable vehicle 80, etc.). When the communication unit 13 receives the predetermined information transmitted by the external communication device 30, the moving body 10c may notify the moving body user U of the reception of the predetermined information by means of voice, light, display on the display or the like.

The vehicle 80 may be equipped with medical treatment 70 for treating the moving body user U. When a person operates the vehicle 80 in response to the communication from the moving body 10c and arrives at the place where the moving body user U is present, for example, quick treatment can be performed. The medical treatment 70 can include various items for treating the moving body user U, such as medicine, bandages, food and the like.

For example, as shown in FIG. 20, when the moving body user U is in distress in a desert area or the like, the moving body 10 (drone) transmits information for a rescue request (including location information of the moving body 10) to the external communication devices 30A to 30C mounted on a medical container, which is a vehicle that can be boarded. As a result, local governments, security companies, etc. are then notified, and upon receiving a request for dispatch, the rescue team can drive the medical container and go to victims.

For example, power generation/storage devices, LPWA receivers (external communication devices 30A to 30C), communication terminals (PCs, tablets, etc.), medical equipment/tools, electricity/water supply equipment, refrigerators/freezers, toilets or the like may be installed in the medical container.

Another embodiment of the moving body of the present invention will be described.

Here, in the moving body 10d, the user-related information stored or acquired by the user-related information unit 20 includes order information for ordering goods or services. By including the order information in the user-related information, it is possible to order the goods or service even from a location away from the location where the moving body user U is present. Thereby, it is expected that, for example, the possibility of being able to order goods or services even in places where it is difficult for radio waves to reach can be improved. The order information is information for ordering goods or services, for example, information for requesting home delivery, work, business trip service, transportation, etc. (information for calling for help is not included). The order information may be text or a number. A provider who provides goods or services provides the goods or the services to the moving body user U when the order information transmitted from the moving body 10d to the external communication device 30 is acquired. Specifically, for example, a trader who has acquired the order information transmitted to the external communication device 30 goes to the location of the moving body user U based on the order information to provide goods or services or send the goods to the location of the moving body user U. The order information may include personal information such as an ID, name, address and gender of the moving body user U. Alternatively, the trader manages personal information such as the ID, name, address, and gender of the moving body user U in advance and compares it with the ID of the moving body user U included in the order information transmitted by the moving body 10d. Thereby, each personal information of the moving body user U may be grasped, and goods or services may be provided to the moving body user U.

In the above-described embodiment, the information acquisition unit 42 may further acquire predetermined status information related to the user U, and the information management unit 41 may further manages the status information acquired by the information acquisition unit 42. The status information represents status (state) information regarding the response to the user U, such as not being rescued, being rescued, being completed to rescue, having a problem, and the problem being solved.

Further, the moving body 10 to 10e are used, for example, for the purpose of informing the user U that his/her own condition is safe, or for the sole purpose of informing others of the location of the user U, etc.

In another embodiment of the present invention, the moving body may be a small aircraft having a transmission unit capable of transmitting an SOS signal. In addition to the SOS signal, the small aircraft can also transmit position information and identification information of the drone or the communication module, and the transmission unit transmits the SOS signal, the position information and the identification information of the drone or the communication module to the outside at intervals of 20 to 70 seconds.

The interval for transmitting the user-related information to the external communication device is preferably 4 to 120 seconds, more preferably 10 to 100 seconds, and even more preferably 20 to 70 seconds. If the transmission interval is less than 4 seconds, the time required for transmission preparation cannot be secured. In addition, there is a risk of interference with downlink signals. If the transmission interval exceeds 120 seconds, the transmission failure probability increases.

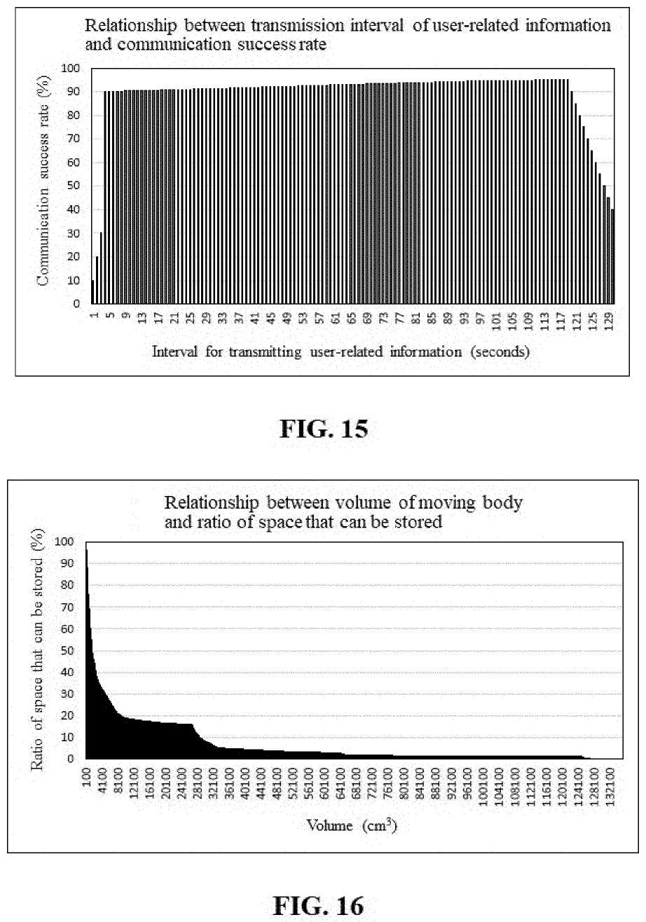

FIG. 15 shows an assumed “relationship between the transmission interval of the user-related information of the moving body 10 and the communication success rate”.

Here, it is preferable that an amount of the information transmitted by the transmission unit is 10 to 200 bytes. Long-distance communication becomes possible by setting the amount of the information to 10 to 200 bytes.

Moreover, from the viewpoint of communication distance and communication volume, it is preferable that the transmission unit transmits the information using radio waves in a frequency band of 900 to 1000 MHz.

Further, it is preferable that a volume of the small aircraft is 100 to 27000 cm³.

By reducing the volume of the moving body 10 (aircraft), it is possible to reduce the size thereof and increase a space in which the moving body 10 can be stored. The volume of the small aircraft is preferably 100 to 125000 cm³, more preferably 200 to 64000 cm³, even more preferably 400 to 27000 cm³. If the volume is less than 100 cm³, flight stability will deteriorate.

FIG. 16 shows an assumed “relationship between the volume of the moving body 10 and the ratio of the space that can be stored”.

A maximum flight time of the small aircraft is preferably 2 to 15 minutes.

By shortening the maximum flight time of the moving body 10 (aircraft), the weight of the moving body can be reduced (downsized and lightened). In addition, by lengthening the maximum flight time of the moving body 10, the probability that user-related information (the SOS signal, the location information, the identification information of the drone or the communication module, etc.) can be transmitted to the external communication devices 30A to 30C is increased. From the above viewpoints, the maximum flight time of the moving body 10 is preferably 2 to 60 minutes, more preferably 3 to 50 minutes, and even more preferably 4 to 40 minutes. Further, when priority is given to weight reduction, the maximum flight time of the moving body 10 is preferably 2 to 15 minutes, more preferably 2 to 10 minutes.

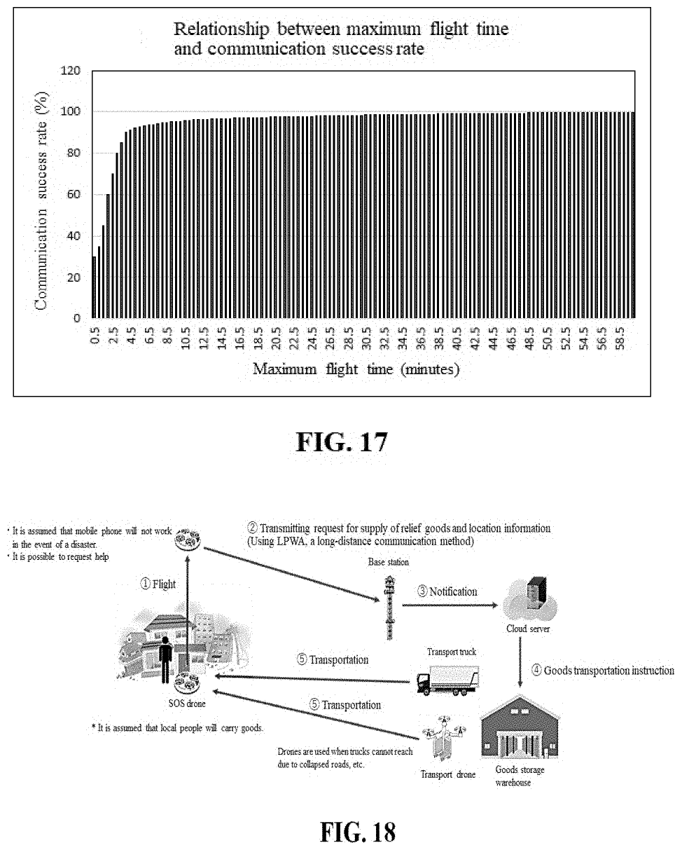

FIG. 17 shows an assumed “relationship between the maximum flight time of the moving body 10 and the communication success rate”.

Another embodiment of the present invention provides a method for delivering by using a drone having a communication unit that transmits information and a server that generates instruction information based on the information transmitted from the communication unit. The method is a method for delivering goods using a drone characterized in that the information transmitted from the communication unit includes the location information of the drone and according to the instruction information, a delivery unit transports the goods to the address identified from the location information of the drone.

For example, in the flow shown in FIG. 18, the moving body user U (drone user) requests goods in the event of a disaster, and a service provider receives the instruction information regarding the delivery of the goods and delivers the goods to the moving body user U. The goods can be delivered by trucks, drones, human power, etc.

Goods request is a request for the delivery of the goods. The address is represented by, for example, latitude and longitude or an address.

Further, it is preferable that the information transmitted from the communication unit includes information on the quantity of goods that needs to be delivered or the type of goods.

For example, after the moving body user U inputs the quantity and the type of goods (goods supply request information) to the operation device 50 (controller) and transmits the information to the moving body 10, the moving body 10 may transmit the goods supply request information to the external communication devices 30A to 30C.

Types of goods include, for example, beverages (water, soft drinks, alcohol, etc.), food (rice, retort food, vegetables, fruits, etc.), daily necessities (tissues, diapers, toilet paper, etc.), fluorescent devices (batteries, flashlights, candles, etc.), medical products (disinfectant, mouthwash, cold medicine, etc.) and the like. For example, if 20 people need water, retort food, tissues and flashlights as goods, the goods supply request information of these goods may be input to the operation device 50.

The goods supply request information may further include information such as name, company name, organization name, location information and status.

The instruction information generated by the server may contain the same information as the goods supply request information above.

The information transmitted from the communication unit may include information on numbers of people who need goods.

Further, the server includes an information management unit that manages user-related information, an information acquisition unit that acquires information transmitted from the communication unit, and a goods information registration unit that registers goods information. When the information transmitted from the communication unit is acquired by the information acquisition unit, it is preferable to generate the instruction information based on the goods information and the user-related information.

For example, the goods information (type and quantity of the goods, etc.) is registered in advance in the server or the like, and when the server or the like acquires the user-related information, it transmits the goods supply instruction information (information for instructing the supply of the goods) to a terminal or the like in the warehouse that supplements the goods.

The user-related information and the goods information may be linked in advance. For example, the goods information (for example, type and quantity of goods to be supplied) may be specified in advance for each user information (name, attribute, company name, ID) of different users.

In the above-described embodiment, the operation device that can operate the drone includes a second communication unit that performs communication, and the second communication unit transmits information regarding the goods to the external communication device.

The operation device 50 alone can be used in addition to the operation of the moving body 10 (drone). For example, the operation device 50 can notify the location of the user by transmitting the location information acquired by GPS or the like to the external transmission devices 30A to 30C. In addition, the goods supply request information and rescue request information (information for requesting rescue) may be transmitted to the external transmission devices 30A to 30C.

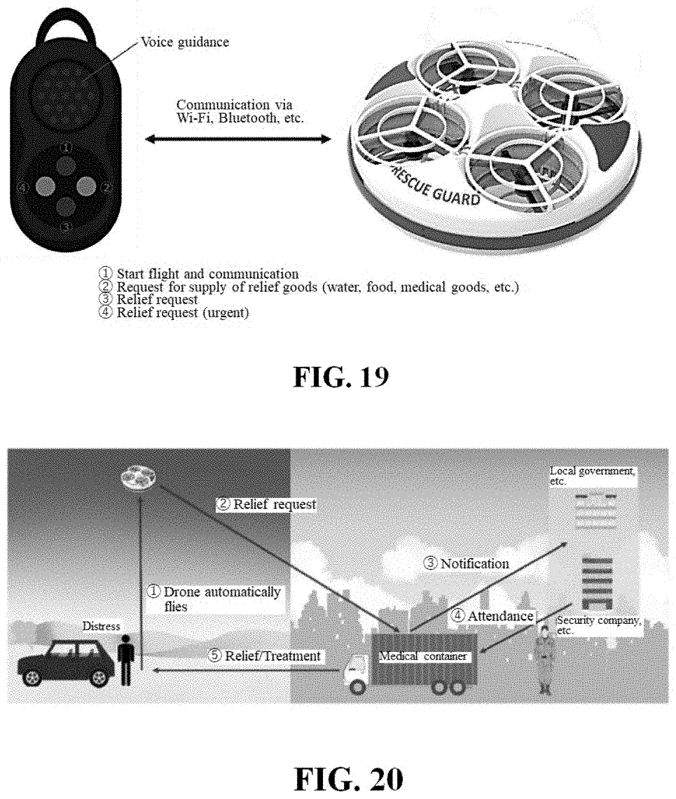

For example, as shown in FIG. 19, a plurality of buttons may be provided, and information corresponding to the plurality of buttons may be transmitted to the moving body 10 or the external communication devices 30A to 30C.

The drone is housed at a predetermined location, and the server stores information about the location where the drone is housed.

For example, the drones are housed in predetermined buildings.

Here, the weight of the drone is preferably 50 to 600 g. Light weight is preferable when it is left in the building and taken out and carried outside.

Further, in each of the above-described embodiments, the moving body may be the aircraft that moves by flying, and the weight of the aircraft may be 50 to 1000 g.

Furthermore, the weight of the moving body 10 (aircraft) is preferably 50 g to 1 kg, more preferably 100 to 800 g, and even more preferably 150 to 600 g, from the viewpoint of flight stability and portability. In the case where more emphasis is placed on portability, the weight of the moving body 10 is preferably 50 to 100 g. The graph below shows the value of horizontal shift (m) when the moving body 10 ascends to an altitude of 30 m at a wind speed of 20 m/s and then lands.

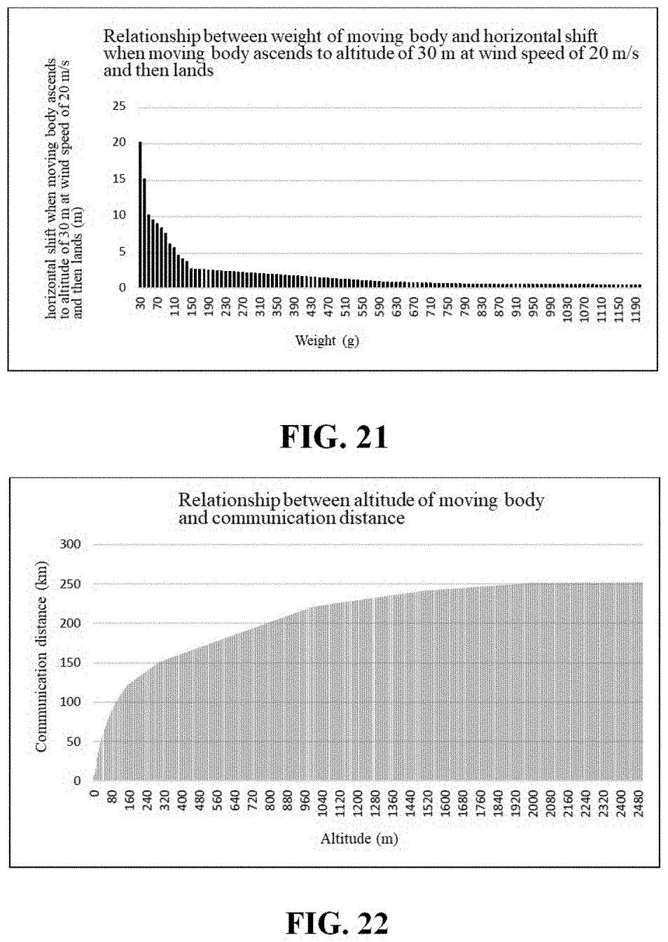

FIG. 21 shows an assumed “relationship between the weight of the moving body 10 and the horizontal shift when the moving body 10 ascends to the altitude of 30 m at the wind speed of 20 m/s and then lands”.

Further, in the above-described embodiment, the moving body is an aircraft that moves by flying, and the moving body may be characterized in that the maximum altitude that the aircraft can reach is 15 to 2000 m.

Furthermore, by increasing the maximum altitude that the moving body 10 (aircraft) can reach, it is possible to increase the communication distance with the external communication devices 30A to 30C. Further, the higher the altitude of the moving body 10 is, the higher the possibility (risk) of crashing is. From these viewpoints, the maximum altitude that the moving body 10 (aircraft) can reach is preferably 15 to 2000 m, more preferably 30 to 1500 m, and even more preferably 50 to 1000 m.

FIG. 22 shows an assumed “relationship between the altitude of the moving body 10 and the communication distance”.

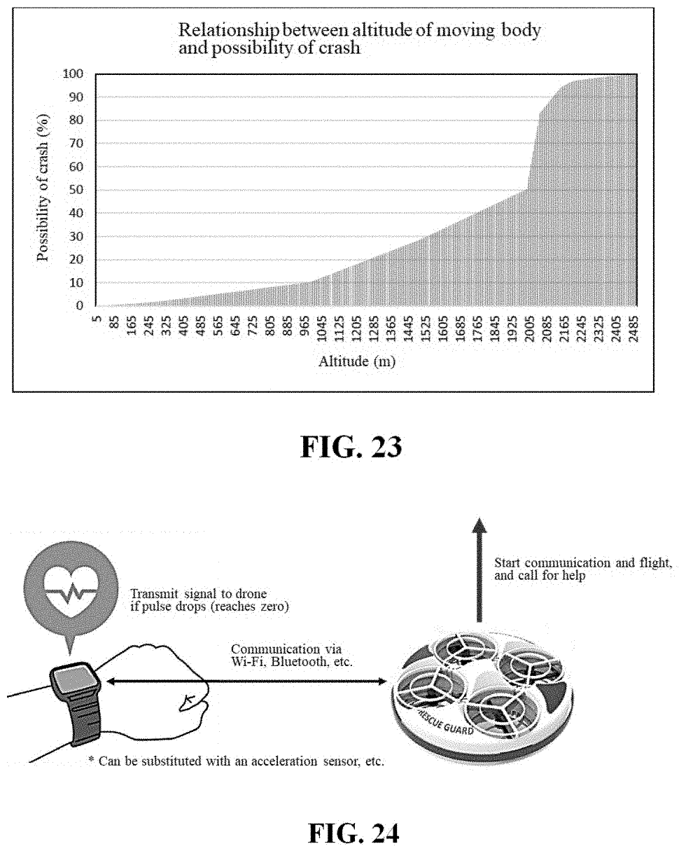

FIG. 23 shows an assumed “relationship between the altitude of the moving body 10 and the possibility of crash”.

Further, in the above-described embodiment, the operation device may be an operation device capable of operating the moving body and has a second communication unit for communication, wherein the second communication unit transmits the user-related information to the moving body or to the external communication device, and wherein the user-related information includes the goods supply request information.

Further, in the above-described embodiment, the moving body may be a moving body characterized in that the moving body includes a biological information receiving unit for receiving biological information of the user and the control unit controls the moving mechanism to move when the biological information receiving unit receives biological information indicating an abnormality of the user.

Furthermore, the biological information may be, for example, information on pulse/heart rate, blood pressure, body temperature and the like. For example, as shown in FIG. 24, the wearable device worn by the moving body user U acquires information on the pulse of the moving body user U, and when the pulse is equal to or less than a predetermined value, it is determined that the moving body user U has an abnormality, and the information indicating that the pulse rate is equal to or less than the predetermined value may be transmitted to the moving body 10 as biological information indicating an abnormality of the moving body user U.

Further, in the above-described embodiment, the management system may be a management system characterized in that the management system includes an information management unit that manages the user-related information including identification information of the moving body, an information acquisition unit that acquires the user-related information transmitted by the communication unit to the external communication device and a goods information registration unit for registering goods information wherein when the information acquisition unit acquires the user-related information transmitted by the communication unit to the external communication device, externally transmits goods supply instruction information based on the goods information registered in the goods information registration unit.

Furthermore, the external may be a designated terminal or the like. For example, it may be a terminal located in a warehouse closest to the address or latitude/longitude location in the location information included in the user-related information.

For example, the goods information (type and quantity of goods, etc.) is registered in advance in a server or the like, and when the server or the like acquires the user-related information, it transmits the goods supply instruction information (information for instructing the supply of goods) to the terminal or the like in the warehouse that supplements the material.

The user-related information and the goods information may be linked in advance. For example, the goods information (for example, type and quantity of goods to be supplied) may be specified in advance for each user information (name, attribute, company name, ID) of different users.

### EXPLANATION OF REFERENCE NUMERAL

1: Moving body system
1A: Bus
1B: Central processing unit
1C: Storage unit
1D: Input unit
1E: Display unit
10, 10a, 10b, 10c, 10d, 10e: Moving body
10A: Bus
10B: Central processing unit
10C: Storage unit
10D: Input unit
10E: Display unit
11: Battery
12: Control unit
13: Communication unit
14: Determination unit
15: Movement mechanism
16: Position specifying unit
17: Current position recording unit
20: User-related information unit
21: Voice storage unit
22: Voice generation unit
23: Setting unit
24: Detection unit
25: Regulation unit
26: Operation unit
30: External communication device
40: Management system
40A: Bus
40B: Central processing unit
40C: Storage unit
40D: Input unit
40E: Display unit
41: Information management unit
42: Information acquisition unit
43: Secondary information display unit
44: Notification unit
50: Operation device
50a: Operation unit
51: Movement instruction unit
52: Voice generation unit
55: Floating portion
60: Fixing portion
70: Medical treatment
80: Vehicle
100: Program
200: Program
U: Moving body user

What is claimed is:

1. A moving body that has a weight of 300 kg or less and is activated by a user to move, the moving body comprising:
a movement mechanism for moving;
a communication unit for performing communication;
a control unit that controls the moving mechanism so that the moving body moves when communication between the communication unit and an external communication device is not possible; and
an attachment for fixing,
wherein the control unit controls the moving mechanism so that the moving body moves when fixation by the attachment is released, and
wherein the communication unit transmits user-related information, which is information related to the user, to the external communication device when the communication between the communication unit and the external communication device is possible.

2. The moving body according to claim 1, wherein a storage space is provided instead of the attachment, and
wherein the control unit controls the movement mechanism so that the moving body moves when taken out of the storage space.

3. The moving body according to claim 1, wherein the weight is in the range of 50 to 1000 g.

4. The moving body according to claim 1, wherein the attachment is provided on a vehicle.

5. The moving body according to claim 2, wherein the user-related information is information relating to car failure or passenger safety status.

6. The moving body according to claim 2, wherein the storage space is provided in a vehicle.

7. The moving body according to claim 4, wherein the user-related information is information relating to car failure or passenger safety status.

8. The moving body according to claim 3, wherein the moving body is a drone.

9. A small aircraft having a transmission unit capable of transmitting an SOS signal,
wherein the small aircraft can also transmit location information and identification information of the drone or communication module in addition to the SOS signal, and
wherein the transmission unit transmits the SOS signals, the location information and the identification information of the drone or the communication module to an outside at intervals of 20 to 70 seconds.

10. The small aircraft according to claim 9, wherein an amount of information transmitted by the transmission unit is in the range of 10 to 200 bytes.

11. The small aircraft according to claim 9, wherein the transmission unit transmits information using radio waves in a frequency band of 900 to 1000 MHz.

12. The small aircraft according to claim 9, wherein a volume of the small aircraft is in the range of 100 to 27000 cm³.

13. The small aircraft according to claim 9, wherein a maximum flight time of the small aircraft is in the range of 2 to 15 minutes.

14. A method for delivering by using a drone having a communication unit that transmits information and a server that generates instruction information based on the information transmitted from the communication unit,
wherein the information transmitted from the communication unit includes location information of the drone, and
wherein a unit for delivering transports goods to an address identified from the location information of the drone.

15. The method for delivering by using the drone according to claim 14, wherein the information transmitted from the communication unit includes information on quantity or type of the goods that needs to be supplied.

16. The method for delivering by using the drone according to claim 14, wherein the information transmitted from the communication unit includes information on numbers of people who need the goods.

17. The method for delivering by using the drone according to claim 14, wherein the server includes: an information management unit that manages user-related information; an information acquisition unit that acquires the information transmitted from the communication unit; and a goods information registration unit that registers goods information, and
wherein when the information transmitted from the communication unit is acquired by the information acquisition unit, the instruction information is generated based on the goods information and the user-related information.

18. An operation device capable of operating the drone according to claim 14, the operation device comprising a second communication unit for performing communication,
wherein the second communication unit transmits information related to goods to an external communication device.

19. The method for delivering by using the drone according to claim 14, wherein the drone is stored at a predetermined location and the server stores information about the location where the drone is stored.

20. The method for delivering by using the drone according to claim 14, wherein a weight of the drone is in the range of 50 to 600 g.
